(19) United States
(12) Patent Application Publication
(10) Pub. No.: US 2006/0170774 A1
(43) Pub. Date: Aug. 3, 2006

(54) Method and apparatus for calibrating and correcting tone scale differences between two or more outputs of a CCD

(75) Inventors: Stephen M. Coppola, Rochester, NY (US); John T. Compton, LeRoy, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/048,469

(22) Filed: Jan. 31, 2005

(51) Int. Cl. H04N 17/02; H04N 17/00

(52) U.S. Cl. 348/175; 348/187; 348/222.1

(57) ABSTRACT

A method for calibrating a camera contemporaneously with image capture where the camera includes an image sensor with two or more output channels, the method includes the steps of providing two or more output channels that receive data from the image sensor; wherein the two or more output channels are respectively connected to two or more portions of the image sensor so that a boundary exists between the portions in a general direction; providing an illumination source that permits illumination of the image sensor substantially parallel to the general direction of the boundary so that creation of a gradient image is permitted in the image sensor; providing a measuring mechanism for permitting measurement of pixel values of the image sensor at a plurality of locations; providing a processor for permitting determination of a mapping function from the plurality of measured values; permitting mapping of pixels in each portion of the image sensor so that one or more pixel values are mapped to different pixel values based on the mapping function; and permitting applying the mapping function to an image captured in close temporal proximity to mapping the one or more pixels.

### FIELD OF THE INVENTION

The invention relates generally to the field of calibrating image sensors, and more particularly, to a method for calibrating image sensors before each image capture.

### BACKGROUND OF THE INVENTION

Currently, images are sometimes readout via two horizontal shift registers which permits images to be read out faster than from one shift register. These two registers inherently include a minor variation between them for which the image should be calibrated. Typically, image sensors are calibrated by capturing an image of a step wedge or step tablet that include a wide range of density patches. The image of the step tablet is used to create a mapping function that is used to match the response of the two outputs to each other.

Although this is satisfactory, it includes drawbacks. One drawback is that manual calibration is undesirable due to time and financial constraints. Another drawback is that the conversion function changes with temperature and various other conditions that makes it desirable to calibrate before each image capture.

Consequently, a need exits for a method for automatically calibrating before each image capture.

### SUMMARY OF THE INVENTION

The present invention is directed to overcoming one or more of the problems set forth above. Briefly summarized, according to one aspect of the present invention, the present invention resides in a method for calibrating a camera contemporaneously with image capture where the camera includes an image sensor with two or more output channels, the method comprising the steps of: (a) providing two or more output channels that receive data from the image sensor; wherein the two or more output channels are respectively connected to two or more portions of the image sensor so that a boundary exists between the portions in a general direction; (b) providing an illumination source that permits illumination of the image sensor substantially parallel to the general direction of the boundary so that creation of a gradient image is permitted in the image sensor; (c) providing a measuring mechanism for permitting measurement of pixel values of the image sensor at a plurality of locations; (d) providing a processor for permitting determination of a mapping function from the plurality of measured values; (e) permitting mapping of pixels in each portion of the image sensor so that one or more pixel values are mapped to different pixel values based on the mapping function; (f) permitting applying the mapping function to an image captured in close temporal proximity to mapping the one or more pixels.

These and other aspects, objects, features and advantages of the present invention will be more clearly understood and appreciated from a review of the following detailed description of the preferred embodiments and appended claims, and by reference to the accompanying drawings.

Advantageous Effect of the Invention

The present invention has the advantage of permitting calibrating image sensors automatically before each image capture if needed.

### BRIEF DESCRIPTION OF THE DRAWINGS

FIG. 1 is a top view of the image sensor of the present invention;

FIG. 2 is a side view of FIG. 1 in which the cover glass is entirely clear in one embodiment and includes a coating with a diffraction grating in another embodiment; and

FIG. 3 is an alternative embodiment of FIG. 1.

### DETAILED DESCRIPTION OF THE INVENTION

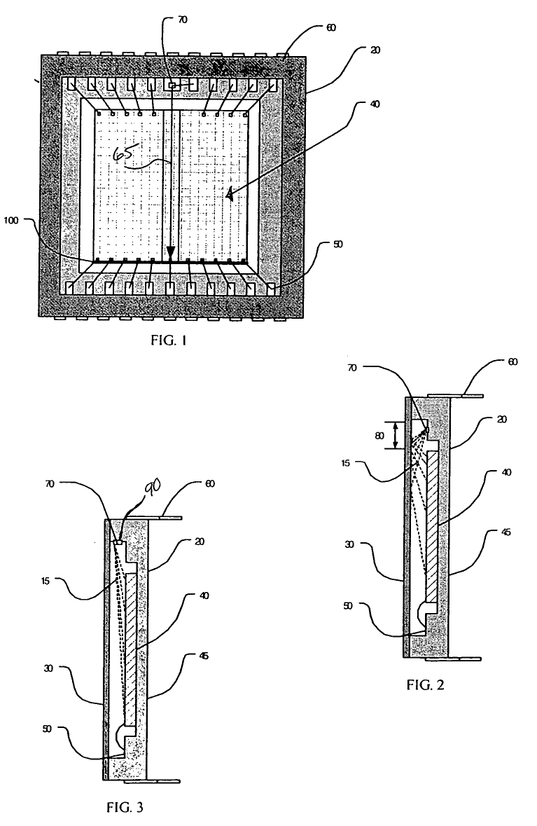

Referring to FIG. 1, there is shown a sensor package 10 having a hollowed out housing 20 having a cover glass 30 over an open portion on the housing 20. An image sensor 40 is disposed in a bottom portion 45 of the housing 20 and a plurality of bond pads 50 are disposed that extend through the housing 20 where they are connected to a plurality of pins 60. A LED 70 is preferably disposed near or substantially near a middle portion of one side of the housing 20. The LED 70 is connected to a pin 60 for power, and to ground via the bond pads 50.

Referring to FIGS. 1 and 2, to calibrate the image sensor 10, the LED 70 is energized for illuminating the image sensor 10. The light (illustrated by the dashed lines 15) from the LED 70 is reflected off the cover glass 30 at a plurality of oblique angles and back onto the image sensor 40. It is noted that a gradient is created since the light is reflected at various angles which redirects the light unevenly across the image sensor 40, as illustrated by the arrow 65. It is noted that the pixels bounded by the parallel lines includes the gradient of which is preferably of particular interest to the present invention.

Referring to FIG. 2, there is shown an alternative embodiment of the present invention. In this embodiment, the cover glass 30 is coated with a diffraction grating over a portion 80 of the cover glass 30 such that a gradient pattern is projected on the sensor 40 when the LED 70 illuminates the image sensor 40. It is noted that the diffraction grating extends preferably only a portion 80 of the cover glass 30 (i.e., the portion not directly over or spanning the image sensor 40) so that incident light for image capture is not inhibited.

Referring to FIG. 3, there is shown another alternative embodiment. The LED 70 is preferably mounted on an interior sidewall 90 of the housing 20 such that the LED 70 directly illuminates the sensor 40.

Referring back to FIG. 1, another alternative embodiment may be implemented by altering the readout. In this regard, the LED 70 illuminates the image sensor 40, and while the image sensor 40 is illuminated, the image sensor 40 is readout via a horizontal shift register 100 (i.e., the last row of pixels of the image sensor 40) so that the lines of the images sensor 40 receives various amounts of light. It is noted that the lines closest to the horizontal shift register 100 receive the shortest exposure and the lines furthest away from the horizontal shift register 100 (i.e., the lines closest to the LED 70) receive the longest exposure. It is also noted that the horizontal shift register 100 may read out in one direction or in two directions, as is well known in the art.

The invention has been described with reference to a preferred embodiment. However, it will be appreciated that variations and modifications can be effected by a person of ordinary skill in the art without departing from the scope of the invention.

Parts List

10 image sensor package

15 light

20 housing

30 cover glass

40 image sensor or pixel array

45 bottom portion

50 bond pads

60 pins

65 arrow

70 LED

80 diffraction grating over a portion of the cover glass

90 interior sidewall

100 horizontal shift register

1. A method for calibrating a camera contemporaneously with image capture where the camera includes an image sensor with two or more output channels, the method comprising the steps of:
(a) providing two or more output channels that receive data from the image sensor; wherein the two or more output channels are respectively connected to two or more portions of the image sensor so that a boundary exists between the portions in a general direction;
(b) providing an illumination source that permits illumination of the image sensor substantially parallel to the general direction of the boundary so that creation of a gradient image is permitted in the image sensor;
(c) providing a measuring mechanism for permitting measurement of pixel values of the image sensor at a plurality of locations;
(d) providing a processor for permitting determination of a mapping function from the plurality of measured values;
(e) permitting mapping of pixels in each portion of the image sensor so that one or more pixel values are mapped to different pixel values based on the mapping function; and
(f) permitting applying the mapping function to an image captured in close temporal proximity to mapping the one or more pixels.

2. The method as in claim 1 further comprising the step of providing a light emitting diode as the light source.

3. The method as in claim 1 further comprising the step of providing a cover glass for reflecting the light from the illumination source onto the image sensor.

4. The method as in claim 3 further comprising the step of coating the cover glass with a grating, which when illuminated by the light source, creates an illumination gradient on the sensor.

5. The method as in claim 1 further comprising the step of mounting the illumination source on an interior sidewall of an image sensor package.

6. A camera comprising
(a) a substrate having a plurality of pixels;
(b) a light source positioned in the camera that obliquely illuminates the image sensor; and
(c) a processor for mapping one or more pixel values to another pixel value based on a mapping function derived from measuring a response of the plurality of pixels to the light source.

7. The camera as in claim 6, wherein the light source is a light emitting diode.

8. A camera comprising
(a) a substrate having a plurality of pixels;
(b) a light source positioned in the camera that is modulated and directly illuminates the image sensor with a light gradient; and
(c) a processor for mapping one or more pixel values to another pixel value based on a mapping function derived from measuring a response of the plurality of pixels to the light source.

9. The camera as in claim 8, wherein the light source is a light emitting diode.

10. A method for calibrating a camera contemporaneously with image capture where the camera includes an image sensor with two or more output channels, the method comprising the steps of:
(a) flushing the image sensor for substantially removing all charge from the image sensor;
(b) illuminating the image sensor with a light source;
(c) reading out the image sensor, while the image sensor is illuminated, so that lines of the image sensor receive a plurality of different exposures while being read out that inherently creates a gradient in an image created from the image sensor;
(d) measuring pixel values of the image sensor at a plurality of locations;
(e) determining a mapping function from the plurality of measured values;
(f) mapping pixels in each portion of the image sensor so that one or more pixel values are mapped to different pixel values based on the mapping function; and
(g) applying the mapping function to an image captured in close temporal proximity to mapping the one or more pixels.
